(19) United States
(12) Patent Application Publication
(10) Pub. No.: US 2024/0211292 A1
(43) Pub. Date: Jun. 27, 2024

(54) AUTOMATICALLY GENERATING NEW DATA FOR USE BY AN APPLICATION IN RESPONSE TO A FORK OF A VIRTUAL MACHINE

(71) Applicant: RED HAT, INC., Raleigh, NC (US)

(72) Inventor: Michael Tsirkin, Yokneam, IL (US)

(21) Appl. No.: 18/145,999

(22) Filed: Dec. 23, 2022

(51) Int. Cl. G06F 9/455

(52) U.S. Cl. CPC G06F 9/45558; G06F 2009/45562; G06F 2009/45591

(57) ABSTRACT

A system can receive a request, from an application executing in a virtual machine, for registering the application to receive fork notifications. The application can be configured to perform an operation using first data. In response to receiving the request, the system can register the application to receive the fork notifications. Subsequent to registering the application to receive fork notifications, the system can determine that the virtual machine has been forked. In response to determining that the virtual machine has been forked, the system can determine that the application is registered to receive fork notifications. Based on determining that the application is registered to receive fork notifications, the system can transmit a fork notification to the application. The application can be configured to receive the fork notification and responsively obtain second data for use in performing the operation.

### TECHNICAL FIELD

The present disclosure relates generally to virtual machines. More specifically, but not by way of limitation, this disclosure relates to automatically generating new data for use by an application in response to a fork of a virtual machine.

### BACKGROUND

A virtual machine is a software emulation of a physical computing device. Like physical computing devices, virtual machines can perform computing tasks and store data. A virtual machine can be ‘forked’ to create a duplicate instance of the virtual machine that can include the same data and occupy the same state. The ‘forked’ instance of the virtual machine can be modified and tested without altering the state of the original instance of the virtual machine.

### BRIEF DESCRIPTION OF THE DRAWINGS

FIG. 1 is a block diagram of an example of a system for automatically generating new data for use by an application in response to a fork of a virtual machine according to some aspects of the present disclosure.

FIG. 2 is a block diagram of an example of a system for automatically generating new data for use by an application in response to a fork of a virtual machine according to some aspects of the present disclosure.

FIG. 3 is a flow chart of a process for automatically generating new data for use by an application in response to a fork of a virtual machine according to some aspects of the present disclosure.

### DETAILED DESCRIPTION

A virtual machine executing on a computing device can be forked to generate a duplicate instance of the virtual machine. The forked instance of the virtual machine can include the same data as the original instance of the virtual machine. Some pieces of data present on the original instance of the virtual machine can be used to perform an operation and may be intended to be unique to the original instance of the virtual machine. For example, the original instance of the virtual machine can include a cryptographic secret that can be used to encrypt information. A cryptographic secret can include a key, passphrase, or any other suitable piece of data that can be used to encrypt information. Generating a duplicate instance of the virtual machine can create a security risk by causing the cryptographic secret in the original instance to be copied to and usable by the duplicate instance of the virtual machine. For example, a malicious actor can retrieve the cryptographic secret from the duplicate instance of the virtual machine. The malicious actor can then use the cryptographic secret to decrypt information that has been encrypted by the original instance of the virtual machine via the cryptographic secret, thereby compromising the security of the encrypted data.

Some examples of the present disclosure can overcome the aforementioned problems by registering an application that is executing on a virtual machine to receive fork notifications. The application can use first data to perform an operation. For example, the first data can be a cryptographic secret that can be used to perform the operation of encrypting information. The system can detect that the virtual machine has been forked and transmit a fork notification to the application to indicate that the virtual machine has been forked. When the application receives a fork notification, it can automatically obtain (e.g., generate or acquire) second data that is different from the first data. For example, the second data may be a new cryptographic secret. The application may then perform subsequent iterations of the operation using the second data, rather than the first data. As a result, the first data may become outdated and may no longer pose a threat if compromised.

More specifically, the application can communicate with a supervisory program that can handle the fork notifications. The supervisory program is a software component that is usually part of the operating system (e.g., the kernel) and can control the execution of various routines; regulate work scheduling, input/output operations, error actions, and similar functions; and regulate the flow of work in a data processing system. The supervisory program can receive a request from the application to register the application to receive fork notifications. In response to receiving the request, the supervisory program can register the application to receive fork notifications in a database. If the supervisory program determines that the virtual machine has been forked, the supervisory program can determine which applications are registered to receive fork notifications. If the supervisory program determines that the application is registered to receive fork notifications, the supervisory program can transmit a fork notification to the application. The application can receive the fork notification and automatically obtain second data that is different from the first data (e.g., a second cryptographic secret that is different from the first cryptographic secret) for use in performing an operation. In some examples, the application can initiate a restartable sequence in response to receiving the fork notification. A restartable sequence can include one or more small segments of user-space code designed to access and modify data structures per-CPU. The system can execute the restartable sequence to generate the second data for use by the application.

In some examples the supervisory program can determine that the virtual machine has been forked in response to receiving a certain notification from a hypervisor associated with the virtual machine. A hypervisor can be a software layer that sits below the virtual machine and above the physical hardware of the host machine. In some cases, the hypervisor can execute on top of an operating system running on the host machine. In other cases, the hypervisor can execute directly on the physical hardware without an operating system beneath it. Either way, the hypervisor can provide interfaces between the virtual machine and the underlying physical hardware of the host machine. The notification may be an interrupt generated by the hypervisor. For example, the hypervisor can generate an interrupt in response to determining that the virtual machine has been forked. The hypervisor can transmit the interrupt to the supervisory program, thereby indicating to the supervisory program that the virtual machine has been forked.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

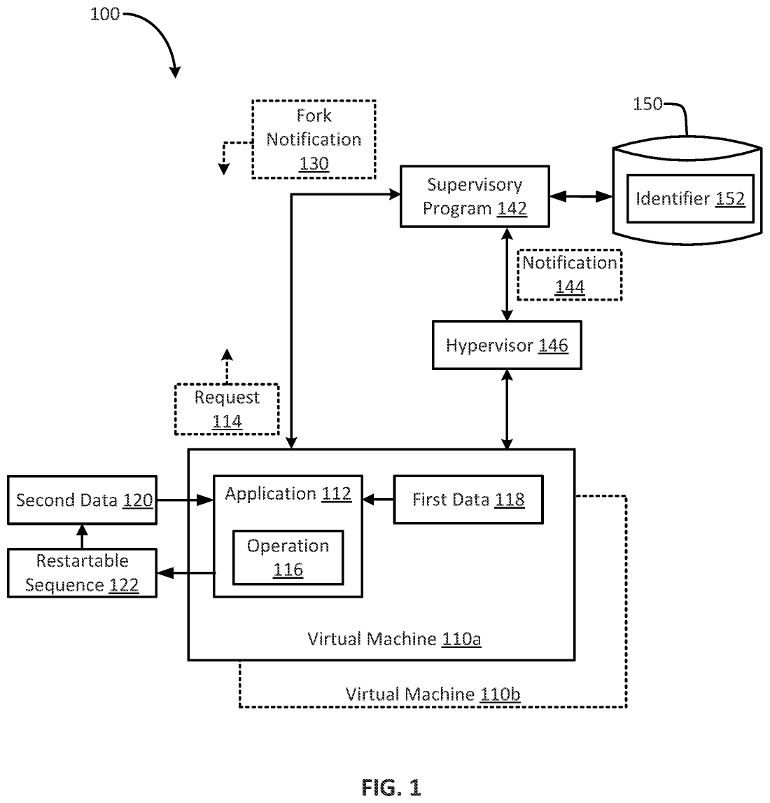

FIG. 1 is a block diagram of an example of a system 100 for automatically generating new data for use by an application 122 in response to a fork of a virtual machine 110a according to some aspects of the present disclosure. The virtual machine 110a can include the application 112, which can perform an operation 116 using first data 118. For example, the first data 118 can be a first cryptographic secret and the application 112 can perform the operation 116 of encrypting information using the first cryptographic secret. In some examples, the first data 118 can be an identification string that can be used to identify the virtual machine by computing devices in the system 100. The identification string can be a string of characters that can be used to identify the virtual machine 110a. In some examples, the identification string can be a title that can be assigned to the virtual machine 110a and can enable a user to identify the virtual machine 110a.

In some examples, the first data 118 can include account data that is sensitive and may be intended to be unique to the virtual machine 110a. For example, the account data can include a passphrase that should not be present on more than one instance of the virtual machine 110a. The operation 116 can include retrieving new account data to replace the old account data, thereby ensuring that the account data is unique to the virtual machine. In some examples, the first data 118 can include a configuration file with information that may be outdated if the virtual machine 110a is forked. For example, the configuration file can include a number of running instances of the virtual machine 110a or a counter indicating the number of times that the virtual machine 110a has been forked. The operation 116 can include retrieving new configuration data to update the configuration file.

In some examples, the application 112 may determine that it is to receive fork notifications and transmit a request 114 to a supervisory program 142 to register the application 112 to receive fork notifications. The supervisory program 142 can receive the request 114 from the application 112. In response to receiving the request 114, the supervisory program 142 can register the application 112 to receive fork notifications. This may involve storing an identifier 152 associated with the application 112 in a datastore 150. The identifier 152 can be a string of characters (e.g., an application title) or a numeric value (e.g., an index) that can be used to identify the application 112. The datastore 150 can be a location in local memory, a database that is accessible to the supervisory program 142, or any other suitable datastore 150.

At some point after the application 112 has registered to receive fork notifications, the virtual machine 110a can be forked to generate a forked instance 110b of the virtual machine 110a. The forked instance 110b can include the same data and occupy the same computing state as the original instance of the virtual machine 110a. The virtual machine 110a can be forked by a hypervisor 146 supporting the virtual machine 110a. For example, the hypervisor 146 may receive a user command to fork the virtual machine 110a and responsively perform the operations to generate the forked instance 110b.

The system 100 can notify the supervisory program 142 of the fork. For example, the hypervisor 146 can transmit a notification 144 to the supervisory program 142 indicating that the virtual machine 110a was forked. The notification 144 may be an interrupt generated by the hypervisor 146. For example, the hypervisor 146 can generate the interrupt in response to the virtual machine 110a being forked or in response to a forked instance 110b of the virtual machine 110a being instantiated. In other examples, the supervisory program 142 may detect the fork based on notifications from other system components.

In response to receiving the notification 144, the supervisory program 142 can determine which applications are registered to receive fork notifications. The supervisory program 142 may make this determination by consulting the datastore 150. For example, the supervisory program 142 can access the datastore 150 to determine which application identifiers are present in the datastore 150.

In response to determining that the application 112 is registered to receive fork notifications, the supervisory program 142 can transmit a fork notification 130 to the application 112. The application 112 can receive the fork notification 130 and responsively obtain second data 120 for performing the operation 116. The second data 120 can be different from the first data 118. For example, the second data 120 can be a second cryptographic secret that is different from the first cryptographic secret. In some examples, the second data 120 can be a second identification string that is different than the original identification string and can be used to identify the virtual machine 110a by computing devices in the system 100.

To obtain the second data 120, in some examples the application 112 can initiate a restartable sequence 122. The restartable sequence 122 can include one or more segments of program code that can enable a computing device that the virtual machine 110a is executing on to perform per-CPU operations. In some examples, the restartable sequence 122 can be executed to generate the second cryptographic secret.

It will be appreciated that although a single application 112 is shown in FIG. 1, other examples may involve multiple applications in a single virtual machine or spread across multiple virtual machines. For instance, one or more supervisory programs may handle fork notifications 130 for multiple applications associated with one or more virtual machines. As a particular example, the supervisory program 142 can register multiple applications associated with multiple virtual machines to receive fork notifications in response to requests from those applications. After registering the applications, the supervisory program 142 may then perform the other functionality described herein to notify those applications of virtual machine forks. The applications can then each generate new data based on a received fork notification.

In some examples, the virtual machine 110a, supervisory program 142, and hypervisor 146 can be distributed across multiple computing devices. For example, the virtual machine 110a, supervisory program 142, and hypervisor 146 may execute on separate nodes from one another in a distributed computing environment. The virtual machine 110a can be forked and distributed to one or more of the nodes in the distributed computing environment. Alternatively, the virtual machine 110a, supervisory program 142, and the hypervisor 146 can execute on a single computing device.

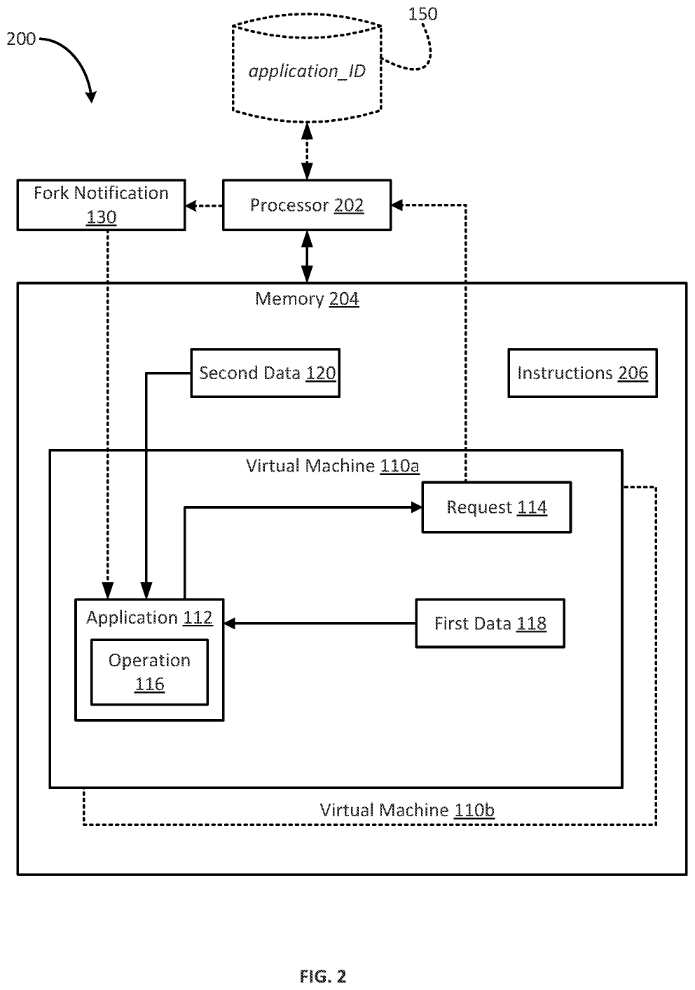

FIG. 2 is a block diagram of an example of a system 200 for automatically generating new data for use by an application 112 in response to a fork of a virtual machine 110a according to some aspects of the present disclosure. The system 200 can include a processor 202 coupled to a memory 204. The processor 202 can include one processor or multiple processors. Examples of the processors 202 include a Field-Programmable Gate Array (FPGA), an application-specific integrated circuit (ASIC), or a microprocessor. The processor 202 can execute instructions 206 stored in the memory 204 to perform one or more operations. In some examples, the instructions 206 can include processor-specific instructions generated by a compiler or an interpreter from code written in any suitable computer-programming language, such as C, C++, C #, and Java.

The memory 204 can include one memory device or multiple memory devices. The memory 204 can be volatile or non-volatile, in that the memory 204 can retain stored information when powered off. Examples of the memory 204 include electrically erasable and programmable read-only memory (EEPROM), flash memory, or any other type of non-volatile memory. At least a portion of the memory device includes a non-transitory computer-readable medium. A computer-readable medium can include electronic, optical, magnetic, or other storage devices capable of providing the processors 202 with the instructions 206 or other program code. Non-limiting examples of a computer-readable medium include magnetic disks, memory chips, ROM, random-access memory (RAM), an ASIC, a configured processor, optical storage, or any other medium from which a computer processor can read the instructions 206.

The application 112 can be configured to use first data 118 to perform an operation 116. For example, the first data 118 can be a first cryptographic secret. The application 112 can use the first cryptographic secret to encrypt data. In some examples, the first data 118 can be a first identification string that can correspond to the virtual machine 110a and can be used to identify the virtual machine 110a.

In some examples, the processor 202 can receive a request 114 from the application 112 to register the application 112 to receive a fork notification 130. The processor 202 can register the application 112 to receive fork notifications based on the request 114. In some examples, the processor 202 can register the application 112 by storing an identifier associated with the application 112 in a datastore 150. The datastore 150 can be a location in local memory, a database, or any other suitable datastore 150.

At a later point in time, the processor 202 can determine that the virtual machine 110a has been forked. In some examples, the processor 202 can determine that the application 112 is forked by receiving a notification from a hypervisor 146 that is associated with the virtual machine 110a indicating that the virtual machine 110a has been forked. In some examples, the notification can be an interrupt generated by the hypervisor 146. For example, the hypervisor 146 can generate the interrupt subsequent to the virtual machine 110a being forked or subsequent to a forked instance of the virtual machine being instantiated.

After the processor 202 determines that the virtual machine 110a has been forked, the processor 202 can determine that the application 112 is registered to receive fork notifications. In some examples, the processor 202 can determine that the application 112 is registered to receive fork notifications by consulting the datastore 150. For example, the processor 202 can access the datastore 150 to determine whether an identifier or flag associated with the application 112 is present in the datastore 150.

Subsequent to determining that the virtual machine 110a has been forked and that the application 112 is registered to receive the fork notification 130, the processor 202 can transmit the fork notification 130 to the application 112. The application 112 can receive the fork notification 130 and responsively obtain second data 120 for performing the operation 116. The second data 120 can be different from the first data 118. For example, the second data 120 can be a second cryptographic secret that is different from a first cryptographic secret. In some examples, the second data can be a second identification string that is different from the first identification string and corresponds to the virtual machine 110a.

In some examples, the instructions 206 can correspond to a supervisory program that is executable by the processor 202, such that some or all of the abovementioned operations can be performed by the supervisory program. The supervisory program can include one or more components of an operating system and can be located on a single computing device or distributed across multiple computing devices. In some examples, the virtual machine 210a can be distributed across multiple computing devices.

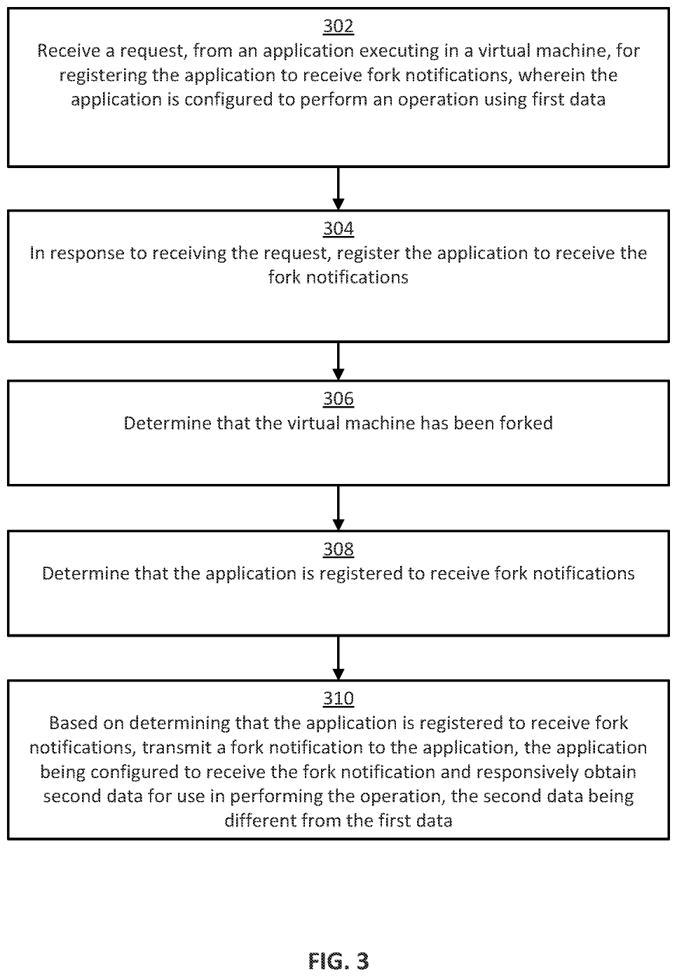

FIG. 3 is a flow chart of a process 300 for automatically generating new data for use by an application 122 in response to a fork of a virtual machine 110a according to some aspects of the present disclosure. Other examples may include more operations, fewer operations, different operations, or a different order of operations than is shown in FIG. 3. The operations of FIG. 3 are described below with reference to the components of FIG. 2 above. In some examples, the operations of FIG. 3 can be performed by a supervisory program executing on the processor 202.

At block 302, the processor 202 receives a request 114, from an application 112 executing in a virtual machine 110a, for registering the application 112 to receive fork notifications. The application 112 can be configured to perform an operation 116 using first data 118. For example, the operation 116 can include encrypting information using the first data 118, and the first data 118 may be a first cryptographic secret.

At block 304, in response to receiving the request 114, the processor 202 registers the application 112 to receive the fork notifications 130. Registering the application 112 to receive the fork notification 130 can involve storing an identifier of the application 112 in any suitable location. For example, the processor 202 can store the identifier of the application 112 in memory (e.g., RAM) or in a storage device. As another example, the processor 202 can store the identifier in a datastore 150. The datastore 150 can include one or more databases, a series of locations in local memory, or any other suitable store of data. The processor 202 can communicate with the datastore 150, for example so that the datastore 150 is accessible to a supervisory program that is executing on the processor 202. The identifier can include a string of characters, a numeric value, or any other data that is associated with the application 112 that is registered to receive fork notifications 130 and can be used to uniquely identify the application 112. In some examples, registering the application 112 to receive the fork notification 130 can involve adjusting a value of a flag in the datastore 150. The value of the flag can indicate a registration status of the application 112.

At block 306, the processor 202 determines that the virtual machine 110a has been forked. The processor 202 can determine that the virtual machine 110a has been forked subsequent to registering the application 112 to receive fork notifications. Determining that the application 112 has been forked can involve consulting a hypervisor that supports the virtual machine 110a. For example, the processor 202 can receive, from the hypervisor, a notification indicating that the virtual machine 110a has been forked. The notification can include information related to the virtual machine 110a such as a unique identifier of the virtual machine. The notification can also include a flag indicating that the virtual machine 110a has been forked. The processor 202 can determine whether the application 112 has been forked based on the value of the flag.

At block 308, the processor 202 determines that the application 112 is registered to receive fork notifications subsequent to determining that the virtual machine 110a has been forked. Determining that the application 112 is registered to receive fork notifications can involve consulting a datastore 150. For example, the processor 202 can transmit a request to the datastore 150 to provide a registration status of the application 112. The processor 202 can receive the registration status from the datastore 150 and determine whether or not the application 112 has been registered to receive fork notifications based on the registration status.

At block 310, the processor 202 transmits a fork notification 130 to the application 112 subsequent to determining that the application 112 is registered to receive fork notifications. The fork notification 130 can include metadata that is associated with to a fork event in which the virtual machine 110a was forked. The metadata can include a timestamp indicating the time at which the virtual machine 110a was forked, an identifier associated with the fork event, or an identifier associated with a new virtual machine instance that may have been instantiated as a result of the fork event. The application 112 can receive the fork notification 130 and responsively obtain second data 120 for use in performing the operation 116, the second data 120 being different from the first data 118.

In some examples, the application 112 can initiate a restartable sequence to generate the second data 120. The restartable sequence can include one or more segments of program code that can cause the processor 202 to generate the second data. In some examples, the application 112 can transmit a signal to the supervisory program instructing the supervisory program to initiate the restartable sequence. The supervisory program can execute the restartable sequence and retrieve second data 120 as an output of the restartable sequence. The supervisory program can transmit the second data 120 to the application 112. In some examples, the restartable sequence can be executed on a separate computing device or on a different processor, and the processor 202 can retrieve, from the separate computing device or different processor, the second data 120.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A system comprising:
a processor; and
a memory including instructions that are executable by the processor to:
receive a request, from an application executing in a virtual machine, for registering the application to receive fork notifications, wherein the application is configured to perform an operation using first data;
in response to receiving the request, register the application to receive the fork notifications;
subsequent to registering the application to receive fork notifications, determine that the virtual machine has been forked; and
in response to determining that the virtual machine has been forked:
determine that the application is registered to receive fork notifications; and
based on determining that the application is registered to receive fork notifications, transmit a fork notification to the application, the application being configured to receive the fork notification and responsively obtain second data for use in performing the operation, the second data being different from the first data.

2. The system of claim 1, wherein the application is configured to initiate a restartable sequence in response to receiving the fork notification, the restartable sequence being executable to generate the second data.

3. The system of claim 1, wherein the instructions are further executable by the processor for causing the processor to determine that the virtual machine has been forked based on a notification received from a hypervisor supporting the virtual machine, the notification indicating that the virtual machine has been forked.

4. The system of claim 3, wherein the notification is an interrupt that is generated by the hypervisor.

5. The system of claim 1, wherein the first data is a first secret and the second data is a second secret.

6. The system of claim 1, wherein the instructions are further executable by the processor for causing the processor to:
register the application to receive the fork notifications by storing an identifier of the application in a datastore; and
determine that the application is registered to receive the fork notifications by consulting the datastore.

7. The system of claim 1, wherein the instructions correspond to a supervisory program that is executable by the processor.

8. A method comprising:
receiving a request, by a processor and from an application executing in a virtual machine, for registering the application to receive fork notifications, wherein the application is configured to perform an operation using first data;
in response to receiving the request, registering, by the processor, the application to receive the fork notifications;
subsequent to registering the application to receive fork notifications, determining, by the processor, that the virtual machine has been forked; and
in response to determining that the virtual machine has been forked:
determining, by the processor, that the application is registered to receive fork notifications; and
based on determining that the application is registered to receive fork notifications, transmitting, by the processor, a fork notification to the application, the application being configured to receive the fork notification and responsively obtain second data for use in performing the operation, the second data being different from the first data.

9. The method of claim 8, wherein the application is configured to initiate a restartable sequence in response to receiving the fork notification, the restartable sequence being executable to generate the second data.

10. The method of claim 8, further comprising:
determining, by the processor, that the virtual machine has been forked based on a notification received from a hypervisor supporting the virtual machine, the notification indicating that the virtual machine has been forked.

11. The method of claim 10, wherein the notification is an interrupt that is generated by the hypervisor.

12. The method of claim 8, wherein the first data is a first secret and the second data is a second secret.

13. The method of claim 8, further comprising:
registering, by the processor, the application to receive the fork notifications by storing an identifier of the application in a datastore; and
determining, by the processor, that the application is registered to receive the fork notifications by consulting the datastore.

14. The method of claim 8, wherein the method is performed by a supervisory program executing on the processor.

15. A non-transitory computer-readable medium comprising program code that is executable by a processor for causing the processor to:
receive a request, from an application executing in a virtual machine, for registering the application to receive fork notifications, wherein the application is configured to perform an operation using first data;
in response to receiving the request, register the application to receive the fork notifications;
subsequent to registering the application to receive fork notifications, determine that the virtual machine has been forked; and
in response to determining that the virtual machine has been forked:
determine that the application is registered to receive fork notifications; and
based on determining that the application is registered to receive fork notifications, transmit a fork notification to the application, the application being configured to receive the fork notification and responsively obtain second data for use in performing the operation, the second data being different from the first data.

16. The non-transitory computer-readable medium of claim 15, wherein the application is configured to initiate a restartable sequence in response to receiving the fork notification, the restartable sequence being executable to generate the second data.

17. The non-transitory computer-readable medium of claim 15, wherein the program code is further executable by the processor for causing the processor to determine that the virtual machine has been forked based on a notification received from a hypervisor supporting the virtual machine, the notification indicating that the virtual machine has been forked.

18. The non-transitory computer-readable medium of claim 17, wherein the notification is an interrupt that is generated by the hypervisor.

19. The non-transitory computer-readable medium of claim 15, wherein the first data is a first secret and the second data is a second secret.

20. The non-transitory computer-readable medium of claim 15, wherein the program code is further executable by the processor for causing the processor to:
register the application to receive the fork notifications by storing an identifier of the application in a datastore; and
determine that the application is registered to receive the fork notifications by consulting the datastore.
